(19) United States
(12) Patent Application Publication
(10) Pub. No.: US 2024/0324545 A1
(43) Pub. Date: Oct. 3, 2024

(54) MODULAR SYSTEM WITH MULTIFUNCTIONAL PARTS TO SEPARATE WASTE AND TRANSPORT ANIMALS

(71) Applicant: CARLOS DE MORAES SANCHEZ, PORTO ALEGRE (BR)

(72) Inventor: CARLOS DE MORAES SANCHEZ, PORTO ALEGRE (BR)

(21) Appl. No.: 18/593,587

(22) Filed: Mar. 1, 2024

(30) Foreign Application Priority Data
Mar. 29, 2023 (BR) BR102023005819

(51) Int. Cl. A01K 1/01

(52) U.S. Cl. CPC A01K 1/0114

(57) ABSTRACT

A modular system with multifunctional parts to separate waste and transport animals with two types of modules. A sanitary module for use with any type of substrate such as urine and humidity from feces absorbing material, either with or without an odor retention box, with or without a basin for hygienic granules, and with or without a hygienic plate. The second module is for animal transport.

### FIELD OF THE INVENTION

This invention refers to a system with two types of modules. A sanitary module for use with any type of substrate (urine and humidity from feces absorbing material), either with or without an odor retention box, with or without a basin for hygienic granules, and with or without a hygienic plate. The second module is for animal transport.

### BACKGROUND OF THE INVENTION

All the solutions on the market have a single function, as a toilet or animal transport box. The technical field of application, when used as a sanitary module, is the separation and environmentally correct disposal of feces and urine (waste). For cats, most solutions found on the market work with the idea of absorbing urine and the liquid part of feces by hygienic granules (substrate), forming moist lumps that are partially removed with paddles. The process is not very effective, as the clumps break, forming fragments that accumulate on the substrate, producing a strong odor that drives away animals and attracts flies. Then, after a few days, all the substrate with waste residues must be discarded, as a kind of urine sludge and small fragments of hygienic granules are formed. The parts must be washed with water and cleaning products before starting a new cycle of use. Some users use specific products to clean their cat toilets, as the basins are impregnated with an odor of ammonia (urea from urine degraded by bacteria). These solutions that use basins with hygienic granules harm the environment, consuming water and cleaning products, subjecting animals and people to repulsive, unhealthy and time-consuming situations, in addition to causing waste of material, causing financial losses because, at the moment of the waste disposal (granules mixed with remains of feces and urine), substrate in usable conditions, still clean and dry, is also discarded.

Another problem with existing solutions on the market is the dust from hygiene granules that forms when cats move around, as they have the habit of digging and covering to bury their waste. This dust can cause allergic reactions and respiratory problems in animals. Added to these problems is the fact that most of these substrates do not come from renewable sources and are not biodegradable. The waste, thus, should not be placed in organic waste, as it contains remains of hygienic granules with feces. This residue of hygienic granules that remains attached to the feces, if discarded in the toilet, causes clogged sewer pipes. Systems that use hygienic granules in conventional toilets (basins with or without a closing structure) also present two problems. Firstly, animals spread sanitary granules around the house, as the grains are small and stick to cats' paws. Secondly, it creates an environmental problem, as waste must be removed at least once a day, and a plastic bag is used for each maintenance.

For dogs, the market basically offers two solutions. Hygienic mats that have the same function and structure as diapers. These are expensive and highly impactful on the environment, as they are produced with synthetic materials from non-renewable sources and are not biodegradable. A problem that occurs with prolonged use of mats, when placed directly on the floor, is corrosion caused by urine. The urine penetrates and corrodes the floor, damaging the property. To solve this problem, the rugs can be placed over basins. The other solution is the use of structures similar to platforms or screens, placed on basins with very low walls. As there is no element that absorbs urine and humidity from feces, this system requires frequent cleaning, at least once a day. The feces rest on this hollow structure and the urine accumulates in the basin. Some people place a hygienic mat under these platforms to absorb urine. This works as a palliative, since it still requires a lot of maintenance for cleaning and the problem of mat disposal continues.

### DESCRIPTION OF THE DRAWINGS

FIG. 1 shows the waste separator drawer with an inclination in perspective and with a longitudinal section;

FIG. 2 shows the substrate concentration marquees;

FIG. 3 shows the sieve with oval fillet mesh;

FIG. 4 shows the opening for the urine and humid waste collection basin;

FIG. 5 shows the basin with inclinations and rounded corners for substrate and for collecting urine and humid waste;

FIG. 6 shows the basin and transport box lid handle;

FIG. 7 shows the ring used to contain the substrate and as a rail for the waste collection basin;

FIG. 8 shows the hygienic plate with recesses and holes;

FIG. 9 shows the tong for collecting waste;

FIG. 10 shows the chassis;

FIG. 11 shows the front frame with door rail;

FIG. 12 shows the support for smooth and pendulum door;

FIG. 13 shows smooth and pendulum door;

FIG. 14 shows the chassis fixing ring;

FIG. 15 shows the sealing covers;

FIG. 16 shows the handle;

FIG. 17 shows the lattice door;

FIG. 18 shows the sanitary module without odor retention box;

FIG. 19 shows the sanitary module with odor retention box;

FIG. 20 shows the transport module

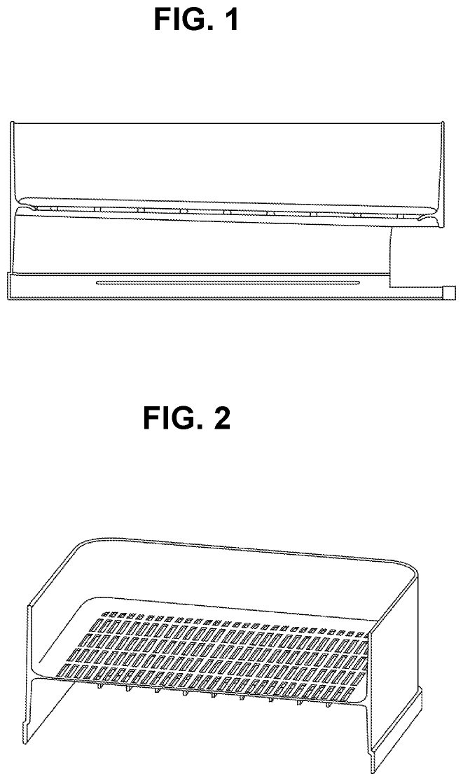

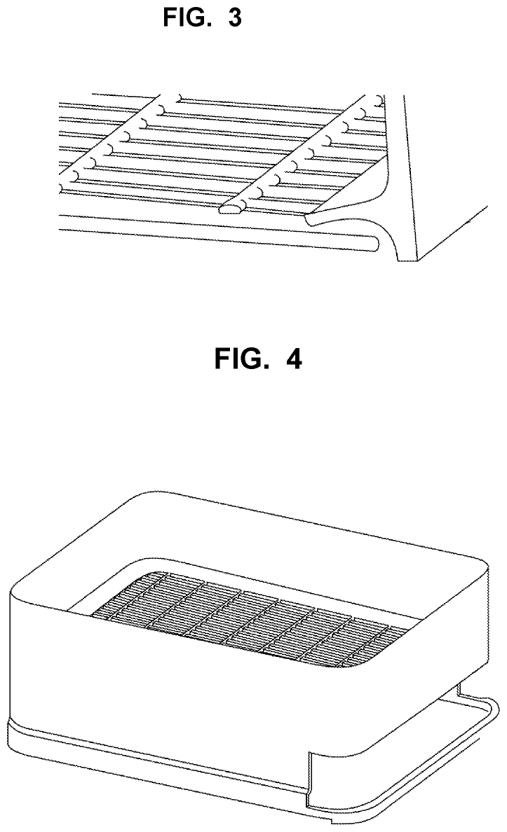

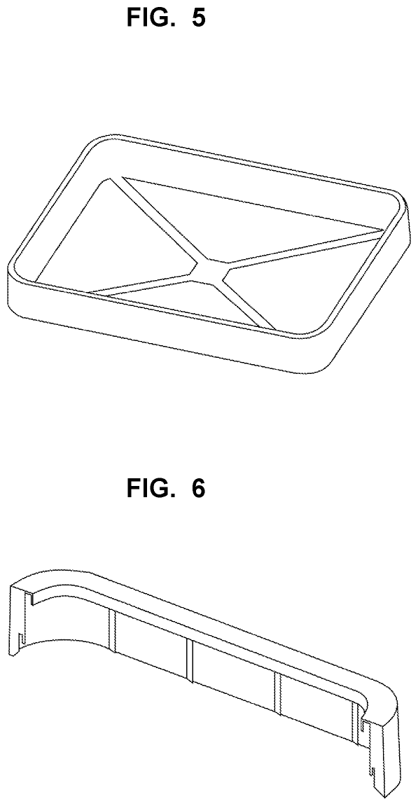

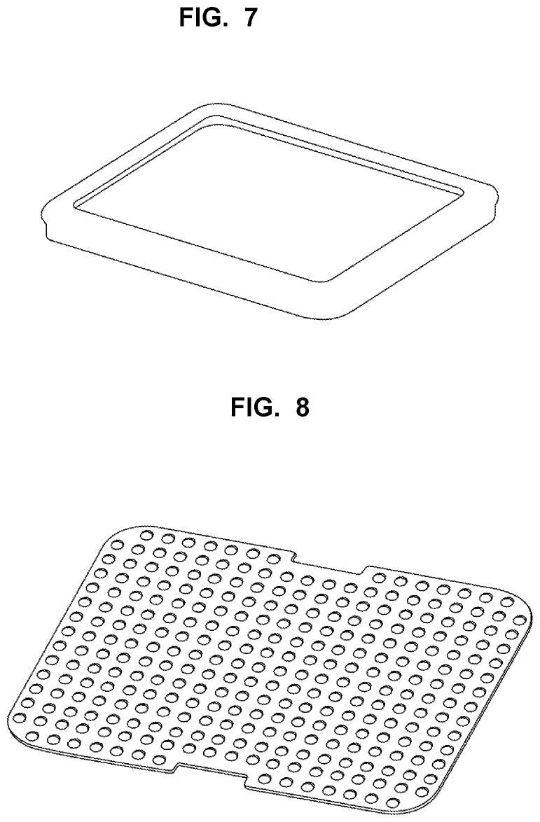

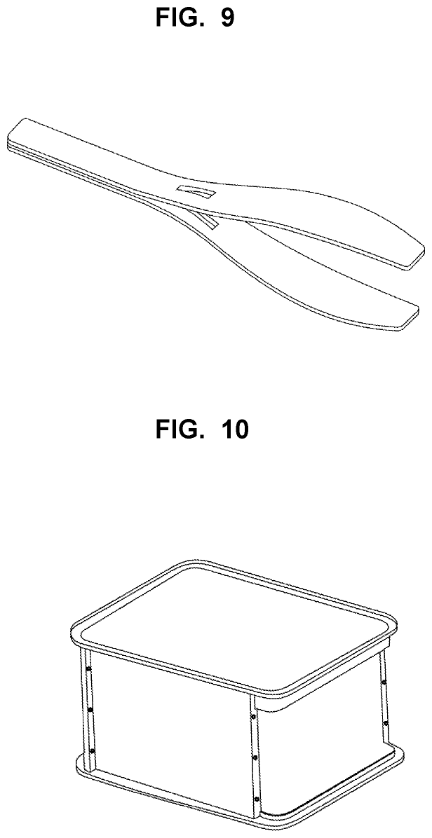

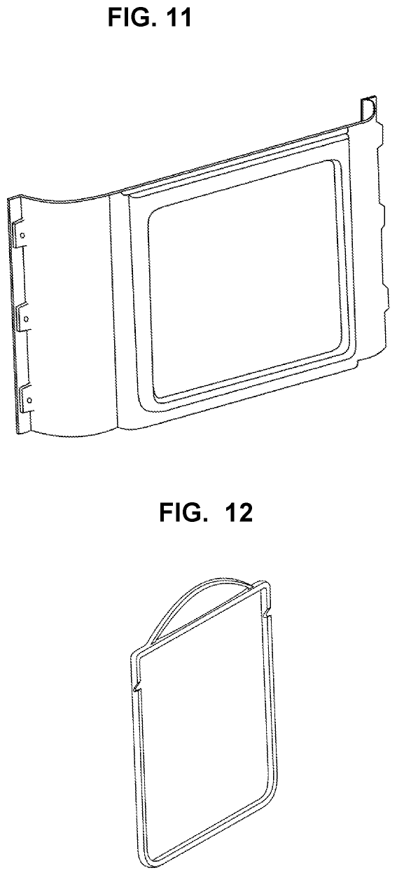

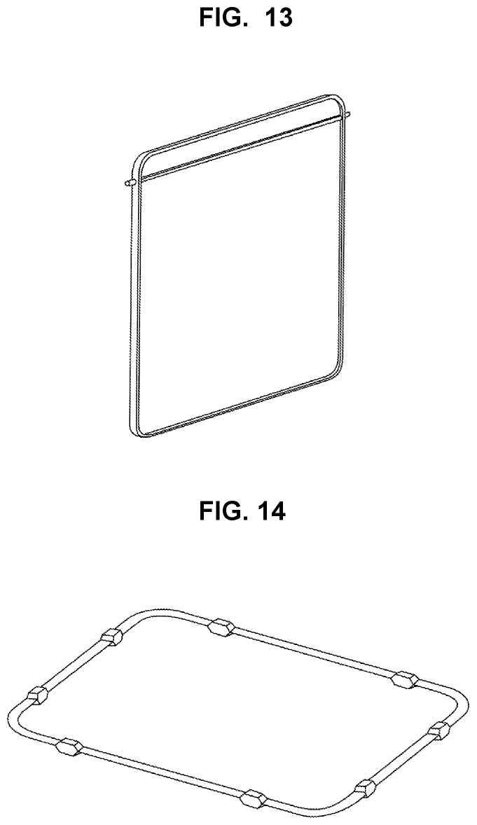

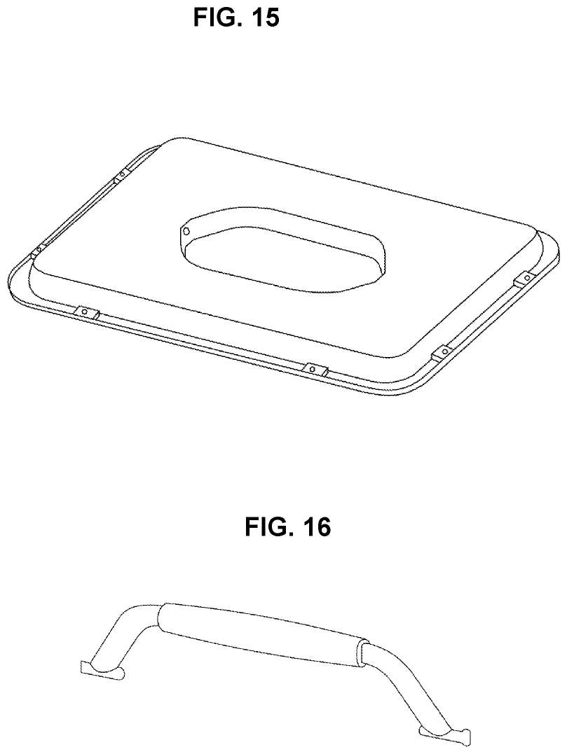

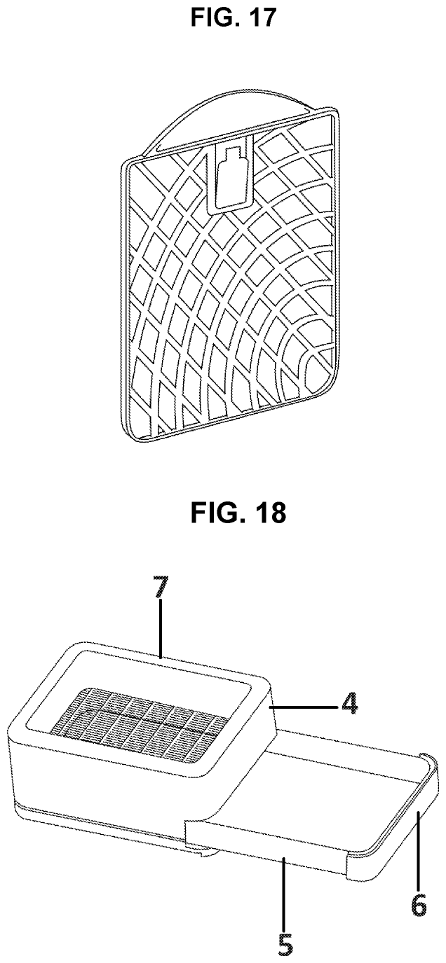

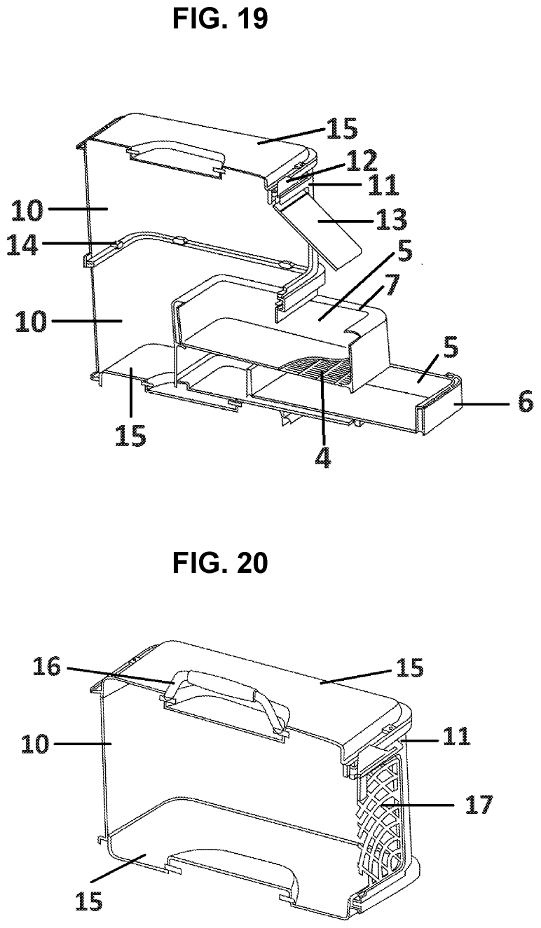

### DESCRIPTION OF THE STATE OF THE ART

Document TWM503753U describes a toilet with automatic sieve and substrate refilling with a solid waste collection container, where clumps formed from the substrate are dispensed, differing from the present solution not only by automation, but also by the design of formation and removal of clumps. It does not have a module that reverses into a transport box or the possibility of operating the sanitary function with or without an odor retention box. Also, it allows no option of using pellets or hygienic granules, for which they make use of the basin with inclinations for waste and residue. It does not allow the use of the hygiene plate for dogs.

Document CN206895474 presents a feces collection model with a retention box with sliding rails and a collection paddle but does not separate urine that forms lumps with the substrate. Excess urine and humid clumps remain in contact with the dry, clean substrate. The shovel presented is not efficient in collecting smaller residues that pass through its mesh. It does not have a module that reverses into a transport box or the possibility of operating the sanitary function with or without an odor retention box. Also, it does not allow the option of using pellets or hygienic granules, for which they use the basin with inclinations for waste and residue. It does not allow the use of the hygiene plate for dogs.

Document U.S. Pat. No. 5,460,122 brings the design of a collection basin, but differs from the present invention in the sense that it does not feature a tilted waste separator drawer that facilitates the separation and removal of feces, with a mesh sieve and oval fillets to facilitate the direct passage of the humid substrate to the collection drawer, with inclined canopies to concentrate the substrate on the mesh, with an opening for the collection basin with inclinations, and a removable ring to contain the substrate. It does not have a module that reverses into a transport box or the possibility of operating the sanitary function with or without an odor retention box. Also, it allows no option of using pellets or hygienic granules, for which they make use of the basin for waste and residue. It does not allow the use of the hygiene plate for dogs.

Document CN205431429 uses the design of urine separation in a tray but does not have a waste separator drawer. It does not have a module that reverses into a transport box or the possibility of using the sanitary function with or without an odor retention box. Also, it allows no option of using pellets or hygienic granules, for which they make use of the basin with inclinations for waste and residue. It does not allow the use of the hygiene plate for dogs.

Document WO2020118112 describes a solution comprising a series of screening trays with waste containment. It differs from the present inventions as it does not have a module that reverses into a transport box or the possibility of operating the sanitary function with or without an odor retention box. Also, it allows no option of using pellets or hygienic granules, for which they make use of the basin with inclinations for waste and residue. Document WO2020118112 does not make cleaning easier for the user, since it increases the number of basins that need to be washed frequently. It does not allow the use of the hygiene plate for dogs.

Document US2017049071, in turn, describes a toilet that has a collection basin for urine and another one with a sieve, but does not feature a tilted waste separator drawer that facilitates the separation and removal of feces, with a mesh sieve and oval fillets to facilitate the direct passage of the humid substrate to the collection drawer, with inclined canopies to concentrate the substrate on the mesh, with an opening for the collection basin, and a removable ring to contain the substrate. It does not have a module that reverses into a transport box and does not allow the operation of the sanitary function with or without an odor retention box. Also, it allows no option of using pellets or hygienic granules, for which they make use of the basin with inclinations for waste and residue. It does not allow the use of the hygiene plate for dogs.

Document CN205511430 describes a toilet that removes urine in its own tray and collects solid waste by changing the sand through an automatic system. It differs from the invention herein because it does not have a module that reverses into a transport box or the possibility of operating the sanitary function with or without an odor retention box. Also, it allows no option of using pellets or hygienic granules, for which they make use of the basin for waste and residue. It does not have a collection basin with inclinations for liquid waste and humid waste with rounded edges and corners. It does not allow the use of the hygiene plate for dogs.

Document JPH08322417, in turn, features a system of basins with sieves for waste disposal, but the solution is limited to exchanging one basin for another, while also lacking a tilted waste separator drawer that facilitates the separation and removal of feces, with a mesh sieve and oval fillets to facilitate the direct passage of the humid substrate to the collection basin, with inclined canopies to concentrate the substrate on the mesh, with an opening for the collection basin with inclinations, and a removable ring to contain the substrate. It does not have a module that reverses into a transport box or the possibility of operating the sanitary function with or without an odor retention box. Also, it allows no option of using pellets or hygienic granules, for which they make use of the basin with inclinations for waste and residue. It does not allow the use of the hygiene plate for dogs.

Document CN106538399 also features a box intended for collecting urine but does not feature a collection basin for liquid waste and humid waste with rounded edges and corners, a waste separator drawer, a module that reserves into a transport box or the possibility of operating the sanitary function with or without an odor retention box. Also, it allows no option of using pellets or hygienic granules, for which they make use of the basin with inclinations for waste and residue. It does not allow the use of the hygiene plate for dogs.

Document CN206212936 features a screening system with overlapping drawers, but it differs from the present invention as it lacks a tilted waste separator drawer that facilitates the separation and removal of feces, with a mesh sieve and oval fillets to facilitate the direct passage of the humid substrate to the collection basin, with inclined canopies to concentrate the substrate on the sieve mesh, with an opening for the collection basin with inclinations, and a removable ring to contain the substrate. It does not have a module that reverses into a transport box or the possibility of operating the sanitary function with or without an odor retention box. Also, it allows no option of using pellets or hygienic granules, for which they make use of the basin with inclinations for waste and residue.

Document US2017196191 describes a box with a raised litter tray resting on the edges of the sides of the box and features a door. It differs from the present solutions since it does not have a waste separator drawer, it does not present a module that reverses into a transport box or the possibility of operating the sanitary function with or without an odor retention box. Also, it allows no option of using pellets or hygienic granules, for which they make use of the basin with inclinations for waste and residue.

The same document US2017196191 also features a system with sieve and drawer for the collection of waste, but it lacks a tilted waste separator drawer that facilitates the separation and removal of feces, with a mesh sieve and oval fillets to facilitate the direct passage of the humid substrate to the collection basin, with inclined canopies to concentrate the substrate on the sieve mesh, with an opening for the collection basin with inclinations, and a removable ring to contain the substrate. It does not have a module that reverses into a transport box or the possibility of operating the sanitary function with or without an odor retention box. Also, it allows no option of using pellets or hygienic granules, for which they make use of the basin with inclinations for waste and residue. It does not allow the use of the hygiene plate for dogs.

Document BE1004660 shows a system of perforated basins with angulations, but without oval fillet mesh to facilitate the direct passage of the humid substrate to the collection basin, with inclined canopies to concentrate the substrate on the sieve mesh, with an opening for the collection basin with inclinations, and without a removable ring to contain the substrate. It has neither a collection basin with rounded edges and corners nor a module that reverses into a transport box. It is not possible to operate the sanitary function with or without an odor retention box. Also, it allows no option of using pellets or hygienic granules, for which they make use of the basin with inclinations for waste and residue. It does not allow the use of the hygiene plate for dogs.

Document CN207054390 also presents the design of a waste collection drawer, while lacks other features such as a waste separator drawer and does not have a module that reverses into a transport box. It does not present the possibility of operating the sanitary function with or without an odor retention box. Also, it allows no option of using pellets or hygienic granules, for which they make use of the basin with inclinations for waste and residue. It does not allow the use of the hygiene plate for dogs.

Document US2010275853 features two drawers for the collection of liquid waste with horizontal sliding rod for feces collection; however, it lacks a tilted waste separator drawer that facilitates the separation and removal of feces, with a mesh sieve and oval fillets to facilitate the direct passage of the humid residue to the collection basin, with inclined canopies to concentrate the substrate on the sieve mesh, with an opening for the collection basin with inclinations, and a removable ring to contain the substrate. It does not have a module that reverses into a transport box or the possibility of operating the sanitary function with or without an odor retention box. Also, it allows no option of using pellets or hygienic granules, for which they make use of the basin with inclinations for waste and residue. It does not allow the use of the hygiene plate for dogs.

Document U.S. Pat. No. 5,515,812 demonstrates a toilet with a removable screen in which urine goes to the bottom of the basin and feces are removed with the screen. It differs in several aspects from the present solution, especially in relation to the waste separator drawer and because it does not present a module that reverses into a transport box nor gives the possibility of operating the sanitary function with or without an odor retention box. Also, it allows no option of using pellets or hygienic granules, for which they make use of the basin with inclinations for waste and residue.

### DETAILED DESCRIPTION OF THE INVENTION

This system features multifunctional parts that assemble the sanitary and transport modules that are used according to the user's needs. For dogs and cats, a sanitary module has an inclined waste separator drawer (1), with substrate concentration canopies (2), with a sieve with oval fillet mesh (3), with an opening (4) for the collection basin with inclinations for liquid waste and waste (5). This basin (5) has rounded edges and corners and has a handle (6). At the base of the walls of the waste separator drawer (1), the ring (7) is attached with the function of a rail for the liquid waste and humid waste collection basin (5). The ring (7) is also used to contain the substrate over the separator drawer (1). The sanitary module can work with or without an odor retention box and can also be used with pellets or sanitary sand and granules. The sand and sanitary granules are placed in the collection basin with inclinations for liquid waste and humid waste (5) on the separator drawer (1) without the handle (6). For specific use with dogs, the separator drawer (1) receives the sanitary plate with perforated recesses (8) that allow urine to drain, being absorbed by the pellets. As an accessory, the sanitary module features tongs (9) for collecting solid waste, thus, the feces are removed with a tong for correct disposal in the toilet. The reduction in substrate use can reach more than 70%, making it an environmentally friendly solution.

For use with cats, the present modular sanitary system solves these problems, based on the design of separating waste from the clean and dry substrate, using as a principle the use of a separator drawer, a collection basin and pine pellets available in the market (pelletized vegetable substrate from a renewable and biodegradable source with high liquid absorption capacity and some vapor absorption). Instead of forming larger portions (humid clumps), as happens with hygienic granules, the opposite occurs. When absorbing urine and humidity from feces, the pellets crumble, returning to the state of sawdust (dust). This sawdust is isolated by the waste separator drawer, passing to the collection basin for liquid waste (urine) and humid waste (sawdust with urine). With the instinctive digging and burying movements made by the animals themselves and with the tongs during maintenance, the feces are clearly visible on the pellets, as they have a very different color and density. This way it is easy to completely remove it, even the smallest fragments. With the solution presented, cats do not carry substrate residues on their paws, as they only step on pellets that are large enough not to get between the cats' toes and are dry, avoiding adhesion by humidity.

The feces are removed with tongs, which are an accessory to the system, and discarded in the toilet, practically free of residual fragments of the pellets. Moving the pellets with the tongs, during maintenance, causes a mechanical self-cleaning effect on the waste separator drawer, as the pellets are dry, rough and hydrophilic, removing all remains of feces that have stuck to the sieve. The presented solution delivers a very large reduction in the substrate used, reaching more than 70%, because when exercising the digging instinct, the sieve is exposed and the urine passes directly to the collection basin, reaching a smaller amount of substrate, in addition of the economy has a lower environmental impact, with a reduction in discarded substrate and the use of plastic bags.

In the invention presented, there is no cyclicality of common operations that use hygienic granules, and which does not have a separator drawer. These cycles begin with the basin cleaned and filled with new hygienic sand and granules, going through a constant process of accumulation of remains of feces and pieces of fragments of clumps, until it is necessary to discard the entire contents, wash the sand basin and sanitary granules and start a new operation. In the invention presented here, in each maintenance operation, the feces are completely removed and the ideal quantity of pellets is filled in the separating sieve, as the material that absorbs urine and humidity from the feces passes through the sieve, falling into the waste and waste basin.

The strong odor produced by conventional toilets that use sanitary granules comes from the gases that form from the degradation of urine by bacteria and the vapors released by feces immediately after animals defecate, especially cats. The problem of odor from urine degradation, in the proposed solution, is minimized as much as possible. This occurs because, in the sanitary module, urine is completely absorbed by pine sawdust pellets, which prevent the development of microorganisms that act to degrade urine, producing a strong ammonia odor. Another factor for the low perception of odor from urine degradation is the architecture of the module that isolates the material in the collection basin. The only way for gases to pass out of the basin is through the layer of pellets that is on the sieve of the separator drawer that is on the collection basin. The pellets, besides filtering and absorbing most gases and vapors that cause bad odors, function as a physical barrier that prevents them from leaving the collection basin. The problem of fecal odor is minimized by using an odor retention box, which is a physical barrier that prevents the dissipation of gases and vapors. Another factor that minimizes the odor of feces in the proposed solution is that pine pellets are hydrophilic, quickly dehydrating feces. In dehydrated feces, there is less proliferation of bacteria, producing less unpleasant odor.

In the proposed system, dry and clean substrate in usable conditions is never discarded and there is no need to wash it with water or cleaning products. Removing humid waste and cleaning the liquid waste and humid waste collection basin are simple activities, as its edges and corners are rounded in a way so that the humid substrate does not adhere to its walls. The collection basin is cleaned with a common brush, meaning there is no need to use water or cleaning products. Cleaning the collection basin does not need to be carried out daily, as there is no dissipation of bad odors and the basin has the capacity to store waste for several days, greatly minimizing the environmental problem of using plastic bags used for disposal. The invention allows feces to be placed in the toilet without substrate residues and the waste containing urine and fecal liquids can go to organic waste or be used to fertilize areas that are not related to food production.

To use the sanitary module with pellets of plant material from renewable sources, they are placed directly on the waste separator drawer (1). When used by animals that have the habit of digging small holes to urinate, most of the urine is not absorbed by the pellets, passing directly to the waste collection basin and humid waste with inclinations (5). The pellets that absorb urine and part of the humidity from feces crumble, passing through the sieve of the separator drawer (1) and falling into the collection basin for liquid waste and humid waste with inclinations (5). This separation occurs due to the action of gravity, the instinctive digging and burying movements made by the animals themselves and the movement of the pellets with the tong (9) when maintaining the system. The feces, already dehydrated by the hydrophilic action of the pellets, are removed with the tong (9), or with a paddle, which is much less effective. This configuration of the system without the substrate basin with inclinations (5) and which uses pellets, causes much less contact between animals and humid waste and residue and very rarely uses water and cleaning products in its maintenance. This configuration is used for dogs, simply placing the hygienic plate (9) over the pellets in the separator drawer.

To use the sanitary module with hygienic granules, two identical basins are used (5). The first is placed on the strainer of the waste separator drawer (1) without the handle (6). In the basin with inclinations for substrate (5), the hygienic granules are placed, which will form clumps when absorbing the urine and part of the humidity from the feces. The system is maintained by pouring all the contents (sand or sanitary granules, feces and urine) from the basin with inclinations for substrate (5), onto the separator drawer (1) with handle (6). The clumps are retained on the sieve of the separating drawer (1) and the crumbled and dry part passes to the second collection basin for liquid waste and humid waste with inclinations (5) and then returns to the first basin with inclinations for substrate (5) which is on the sieve of the separator drawer (1). This configuration with a basin with inclinations for substrate (5) does not suit dogs, so the hygienic plate (8) with perforated recesses does not appear.

To prevent insects from approaching and isolate bad odors, it is possible to assemble the sanitary module with the odor retention box for dogs and cats. This configuration is composed of two equal chassis (10), a front frame with door rail (11), a support for the smooth and pendulum door (12), a smooth and pendulum door (13), a chassis fixing ring (14), top and bottom covers (15), in addition to the sanitary module. The sanitary module can be used with pellets and without the substrate basin (5), or with sand and hygienic granules, with the substrate basin. In this configuration, the sanitary module is attached to the first chassis (9) which is located at the bottom of the odor retention box. The fixing ring (14) is attached to the upper edges of this chassis (10), which, in turn, is attached to the lower edges of the second chassis (10), which is in the upper part of the odor retention box. The second chassis receives the front frame with the track for the doors (11), the support for the smooth and pendulum door (13) and the smooth and pendulum door (13), which allows the animals to circulate. To close the sanitary module with the odor retention box, two sealing covers (14) are fitted, one at the top and the other at the bottom of the set of coupled chassis (10). To use this configuration with dogs, the hygiene plate with perforated recesses (8) is used.

Finally, the transport module is composed of the chassis (10) that forms its structure. The front frame is attached to it with door rails (12), the lower and upper sealing covers (15), the latter with a handle (16). In the transport module, the smooth and pendulum door (13) is replaced by the lattice door (17).

1. Modular system with multifunctional parts to separate waste and transport animals, comprising:
a sanitary module with inclined waste separator drawer;
a substrate concentration canopies;
sieve with oval fillet mesh;
an opening for collection basin with inclinations for liquid waste and humid waste;
a handle;
a ring;
a sanitary plate with perforated recesses.

2. Modular system with multifunctional parts to separate waste and transport animals, according to claim 1, further comprising:
a sanitary module with an odor retention box comprising chassis;
a front frame with door rail;
a support for the smooth and pendulum door;
a smooth and pendulum door;
a fixing ring;
top and bottom covers;
a handle.

3. Modular system with multifunctional parts to separate waste and transport animals, animals according to claim 1, further comprising a tong.

4. Modular system with multifunctional parts to separate waste and transport animals having a module of transport made up of multifunctional parts, comprising:
a chassis;
a front frame with door rail;
a fixing ring;
top and bottom covers;
a handle;
a lattice door.
